(19) United States
(12) Patent Application Publication
(10) Pub. No.: US 2024/0014503 A1
(43) Pub. Date: Jan. 11, 2024

(54) BATTERY MODULE

(71) Applicant: Prime Planet Energy & Solutions, Inc., Tokyo (JP)

(72) Inventors: Takashi INAMURA, Himeji-shi (JP); Takatoshi KAGEYAMA, Kakogawa-shi (JP); Takuya EGASHIRA, Himeji-shi (JP)

(21) Appl. No.: 18/343,740

(22) Filed: Jun. 29, 2023

(30) Foreign Application Priority Data
Jul. 6, 2022 (JP) 2022-108991

(51) Int. Cl. H01M 50/308; H01M 50/358; H01M 50/342

(52) U.S. Cl. CPC H01M 50/308; H01M 50/358; H01M 50/3425

(57) ABSTRACT

A battery module includes: a plurality of battery cells arranged in a first direction; and a cover member provided above the plurality of battery cells. Each of the plurality of battery cells includes a housing having a gas-discharge valve, and an electrode terminal provided on the housing. The cover member includes a first region and a second region having a strength lower than a strength of the first region. The first region is located above at least one of the electrode terminals. The second region is located above at least one of the gas-discharge valves.

### CROSS REFERENCE TO RELATED APPLICATIONS

This nonprovisional application is based on Japanese Patent Application No. 2022-108991 filed on Jul. 6, 2022, with the Japan Patent Office, the entire contents of which are hereby incorporated by reference.

### BACKGROUND OF THE INVENTION

### Field of the Invention

The present technology relates to a battery module.

### Description of the Background Art

There has been conventionally known a technology of opening part of an exterior container of a battery cell included in a battery module so as to discharge an internal gas when a pressure in the exterior container is increased. Similarly, there has been also known a technology of opening part of a pack case so as to discharge an internal gas when a pressure in the case of the battery pack is increased.

### SUMMARY OF THE INVENTION

In a battery module having a structure in which a cover member is provided above a plurality of battery cells, when part of an exterior container of a battery cell is opened in response to an increased pressure in the exterior container, if the cover member is blown off by a gas sent out from the exterior container, a bus bar, a voltage detection line, or the like is exposed. When a material sent out from the inside of the exterior container and including a metal is adhered to the exposed bus bar, voltage detection line, or the like, an electrical short circuit may occur.

It is an object of the present technology to provide a battery module to suppress an electrical short circuit caused by a material sent out from a battery cell.

The present technology provides the following battery module.

[1] A battery module comprising: a plurality of battery cells arranged in a first direction; and a cover member provided above the plurality of battery cells, wherein each of the plurality of battery cells includes a housing having a gas-discharge valve, and an electrode terminal provided on the housing, the cover member includes a first region and a second region having a strength lower than a strength of the first region, the first region is located above at least one of the electrode terminals, and the second region is located above at least one of the gas-discharge valves.

[2] The battery module according to [1], wherein the second region extends in the first direction so as to be located above at least a plurality of the gas-discharge valves.

[3] The battery module according to [1] or [2], wherein the second region is provided with a notch portion, a thin portion, or a groove portion formed in the cover member.

[4] The battery module according to [1] or [2], wherein the second region is formed by providing a detachable lid at a cavity of the cover member.

[5] The battery module according to [1] or [2], wherein the second region is formed with the second region of the cover member being composed of a material having a relatively low strength as compared with the first region.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a basic configuration of a battery module.

FIG. 2 is a perspective view showing a battery cell.

FIG. 3 is a perspective view showing a state in which a wiring module is provided on the battery module.

FIG. 4 is a top view of the battery module.

FIG. 5 is a diagram schematically showing a state in which a gas is discharged from the battery cell.

FIG. 6 is a diagram schematically showing a periphery of a second region of a cover member.

FIG. 7 is a perspective view showing a modification of the second region.

FIG. 8 is a cross sectional view showing the second region shown in FIG. 7.

FIGS. 9 to 13 are cross sectional views showing further modifications of the second region of the cover member.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery. In the present specification, the term “electrode” may collectively represent a positive electrode and a negative electrode. Further, the term “electrode plate” may collectively represent a positive electrode plate and a negative electrode plate.

In the present specification, the “battery cell” can be mounted on vehicles such as a hybrid electric vehicle (HEV), a plug-in hybrid electric vehicle (PHEV), and a battery electric vehicle (BEV). It should be noted that the use of the “battery cell” is not limited to the use in a vehicle.

FIG. 1 is a diagram showing a basic configuration of a battery assembly 1. As shown in FIG. 1, battery assembly 1 includes battery cells 100, end plates 200, and a restraint member 300.

The plurality of battery cells 100 are provided side by side in a Y axis direction (first direction). Thus, a stack of battery cells 100 is formed. Each of battery cells 100 includes electrode terminals 110. A separator (not shown) is interposed between the plurality of battery cells 100. The plurality of battery cells 100, which are sandwiched between two end plates 200, are pressed by end plates 200, and are therefore restrained between two end plates 200.

End plates 200 are disposed on both ends of battery assembly 1 in the Y axis direction. Each of end plates 200 is fixed to a base such as a case that accommodates battery assembly 1. Restraint member 300 connects two end plates 200 to each other.

Restraint member 300 is fixed to end plates 200 with a compression force in the Y axis direction being exerted to the stack of the plurality of battery cells 100 and end plates 200, and then the compression force is released, with the result that tensile force acts on restraint member 300 that connects two end plates 200 to each other. As a reaction thereto, restraint member 300 presses two end plates 200 in directions of bringing them closer to each other.

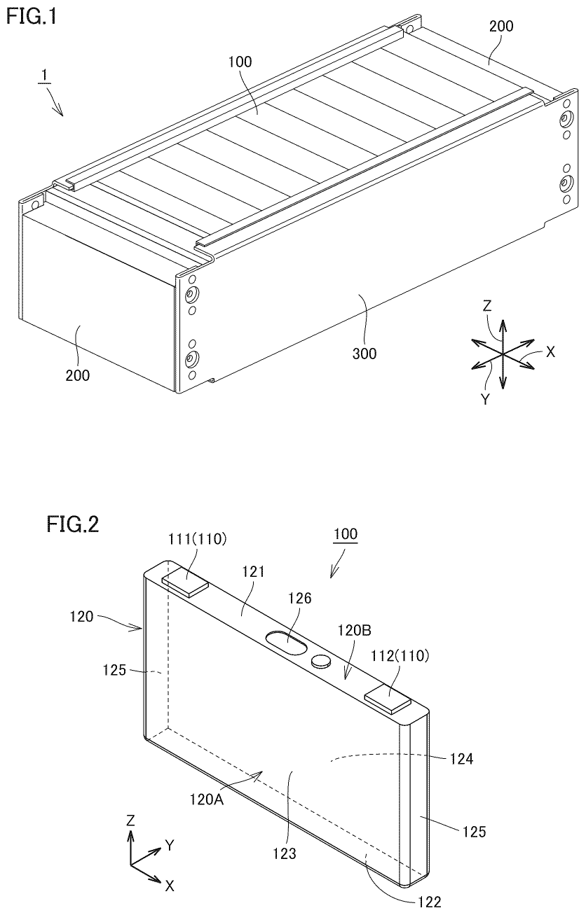

FIG. 2 is a perspective view showing a battery cell 100. As shown in FIG. 2, battery cell 100 has a prismatic shape. Battery cell 100 has electrode terminals 110, and a housing 120 (exterior container). That is, battery cell 100 is a prismatic secondary battery cell.

Electrode terminals 110 are formed on housing 120. Electrode terminals 110 have a positive electrode terminal 111 and a negative electrode terminal 112 arranged side by side along an X axis direction (second direction) orthogonal to the Y axis direction (first direction). Positive electrode terminal 111 and negative electrode terminal 112 are provided to be separated from each other in the X axis direction.

Housing 120 has a rectangular parallelepiped shape and forms an external appearance of battery cell 100. Housing 120 includes: a case body 120A that accommodates an electrode assembly (not shown) and an electrolyte solution (not shown); and a sealing plate 120B that seals an opening of case body 120A. Sealing plate 120B is joined to case body 120A by welding.

Housing 120 has an upper surface 121, a lower surface 122, a first side surface 123, a second side surface 124, and two third side surfaces 125. Housing 120 is provided with a gas-discharge valve 126.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

The plurality of battery cells 100 are stacked such that first side surfaces 123 of battery cells 100, 100 adjacent to each other in the Y direction face each other and second side surfaces 124 of battery cells 100, 100 adjacent to each other in the Y axis direction face each other. Thus, positive electrode terminals 111 and negative electrode terminals 112 are alternately arranged in the Y axis direction in which the plurality of battery cells 100 are stacked.

Gas-discharge valve 126 is provided in upper surface 121. When the temperature of battery cell 100 is increased (thermal runaway) and internal pressure of housing 120 becomes more than or equal to a predetermined value due to gas generated inside housing 120, gas-discharge valve 126 discharges the gas to outside of housing 120.

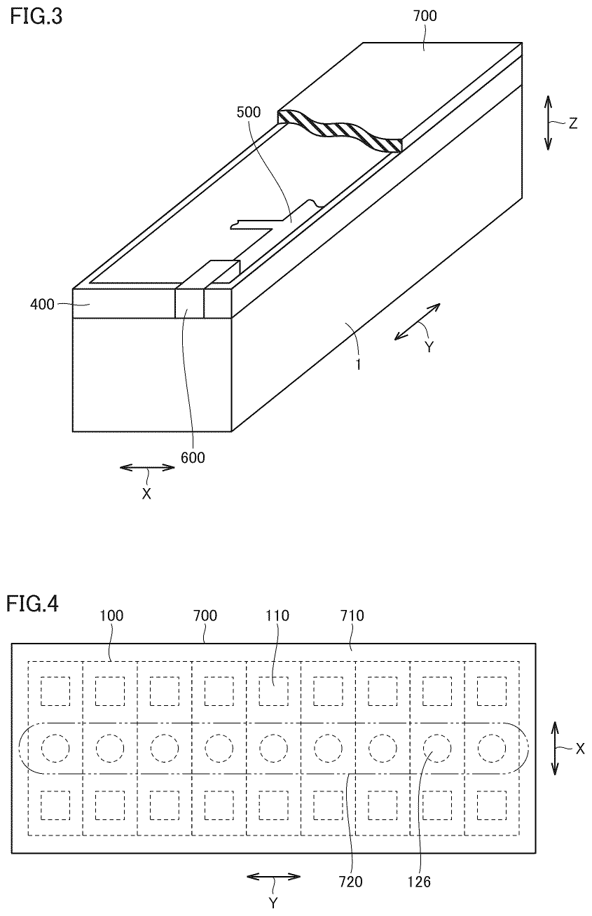

FIG. 3 is a perspective view showing a state in which a wiring module is provided on battery assembly 1. As shown in FIG. 3, a plate member 400 is placed on battery assembly 1, and a flexible printed circuit board 500 is provided on plate member 400. Flexible printed circuit board 500 can be electrically connected to an external device via a connector 600. A cover member 700 is provided on plate member 400 so as to cover flexible printed circuit board 500. It should be noted that instead of flexible printed circuit board 500, an electric wire or a flexible flat cable (FFC) may be used as a voltage detection line.

FIG. 4 is a top view of the battery module. As shown in FIG. 4, cover member 700 provided above the plurality of battery cells 100 includes a first region 710 and a second region 720.

First region 710 extends in the Y axis direction so as to be located above the plurality of electrode terminals 110. First region 710 may be formed to be located above at least one electrode terminal 110.

The second region extends in the Y axis direction so as to be located above the plurality of gas-discharge valves 126. Second region 720 may be formed to be located above at least one gas-discharge valve 126. Second region 720 is formed to have a strength lower than that of first region 710.

FIG. 5 schematically shows a state in which a gas is discharged from battery cell 100. As shown in FIG. 5, when gas-discharge valve 126 is opened in response to an increased internal pressure of housing 120 of battery cell 100, if cover member 700 is blown off by a gas sent out from gas-discharge valve 126, a conductive member such as a bus bar or a voltage detection line is exposed. When a material sent out from the inside of housing 120 and including a metal is adhered to the conductive member, an electrical short circuit may occur. Since each of these conductive members is electrically connected to electrode terminal 110 of battery cell 100, the conductive member is located away from the center in the X axis direction (second direction).

On the other hand, in the battery module according to the present embodiment, in cover member 700 provided above the plurality of battery cells 100, second region 720 having a relatively low strength is provided above gas-discharge valve 126. Hence, when a gas is sent out from gas-discharge valve 126, second region 720 of cover member 700 located above gas-discharge valve 126 can be selectively broken. As a result, first region 710 located above electrode terminal 110 can be protected, i.e., first region 710 can be maintained above the conductive member. Therefore, it is possible to suppress an electrical short circuit caused by the material sent out from battery cell 100 being adhered to the conductive member.

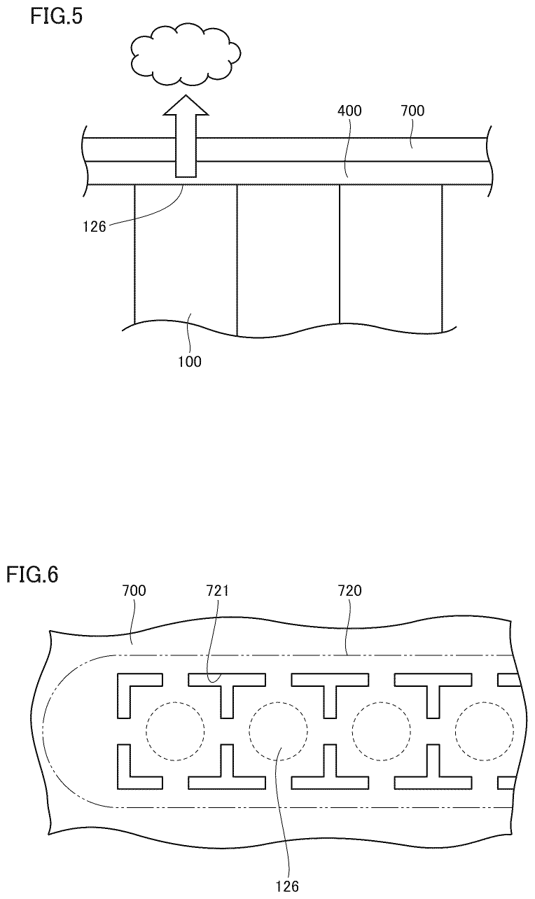

FIG. 6 is a diagram schematically showing the periphery of second region 720. In the example shown in FIG. 6, cover member 700 is provided with notch portions 721 formed to surround an upper region of gas-discharge valve 126. Thus, second region 720 is selectively broken when a gas is sent out from gas-discharge valve 126, thereby protecting first region 710 of the cover member.

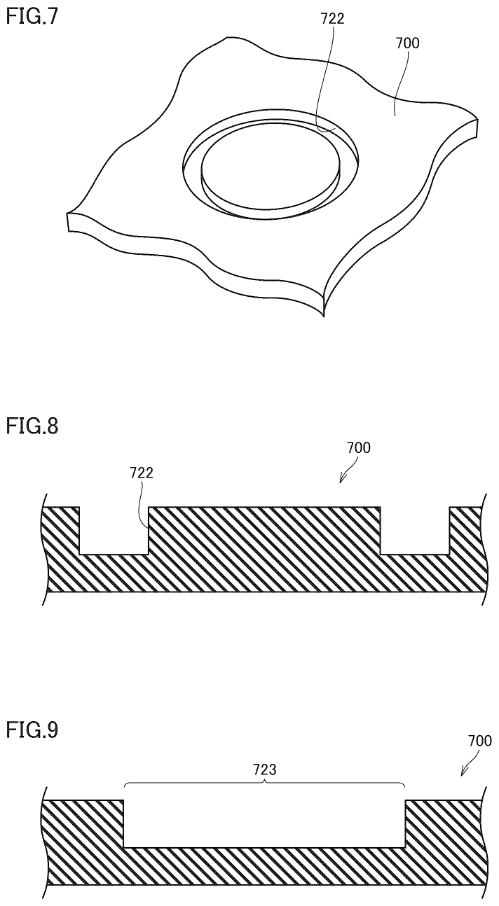

FIG. 7 is a perspective view showing a modification of second region 720. FIG. 8 is a cross sectional view showing second region 720 shown in FIG. 7. In the modification of FIGS. 7 and 8, a groove portion 722 having a substantially circular shape is formed in cover member 700 so as to selectively break second region 720 when a gas is sent out from gas-discharge valve 126, thereby protecting first region 710 of the cover member.

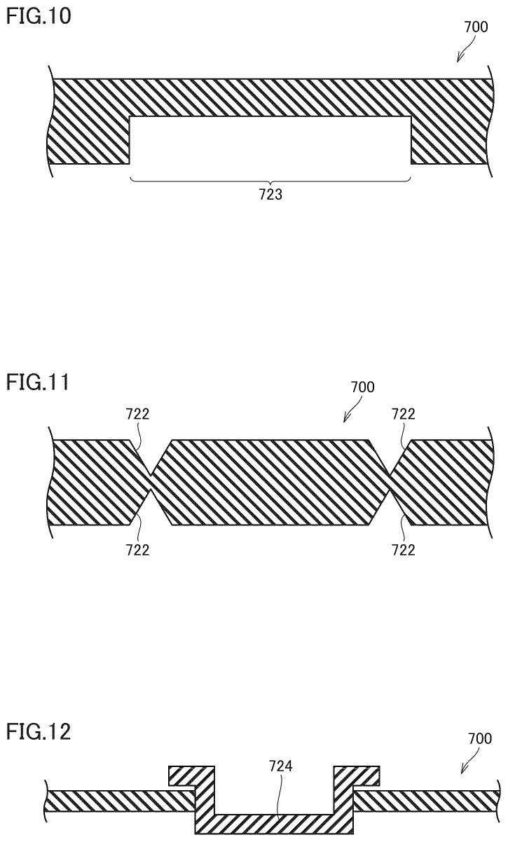

FIGS. 9 to 13 are cross sectional views showing further modifications of second region 420. Second region 720 may be formed by forming a thin portion 723 in a portion of cover member 700 as shown in FIGS. 9 and 10, or second region 720 may be formed by forming a groove portion 722 having a cross sectional shape different from that of FIG. 8 as shown in FIG. 11.

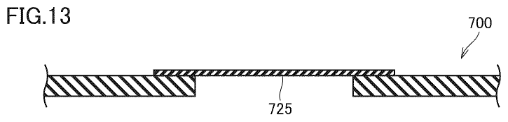

Second region 720 may be formed by detachably providing a separate component 724 (lid), which is composed of another material such as a resin or a rubber, at a hole portion of cover member 700 as shown in FIG. 12, or second region 720 may be formed by attaching a separate component 725, which is composed of another material such as a tape or a net, at the hole portion of cover member 700 as shown in FIG. 13.

Further, second region 720 may be formed with second region 720 of cover member 700 being composed of a material having a relatively low strength as compared with first region 710.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A battery module comprising:
a plurality of battery cells arranged in a first direction; and
a cover member provided above the plurality of battery cells, wherein
each of the plurality of battery cells includes a housing having a gas-discharge valve, and an electrode terminal provided on the housing,
the cover member includes a first region and a second region having a strength lower than a strength of the first region,
the first region is located above at least one of the electrode terminals, and
the second region is located above at least one of the gas-discharge valves.

2. The battery module according to claim 1, wherein the second region extends in the first direction so as to be located above at least a plurality of the gas-discharge valves.

3. The battery module according to claim 1, wherein the second region is provided with a notch portion, a thin portion, or a groove portion formed in the cover member.

4. The battery module according to claim 1, wherein
the second region extends in the first direction so as to be located above at least a plurality of the gas-discharge valves, and
the second region is provided with a notch portion, a thin portion, or a groove portion formed in the cover member.

5. The battery module according to claim 1, wherein the second region is formed by providing a detachable lid at a cavity of the cover member.

6. The battery module according to claim 1, wherein
the second region extends in the first direction so as to be located above at least a plurality of the gas-discharge valves, and
the second region is formed by providing a detachable lid at a cavity of the cover member.

7. The battery module according to claim 1, wherein the second region is formed with the second region of the cover member being composed of a material having a relatively low strength as compared with the first region.

8. The battery module according to claim 1, wherein
the second region extends in the first direction so as to be located above at least a plurality of the gas-discharge valves, and
the second region is formed with the second region of the cover member being composed of a material having a relatively low strength as compared with the first region.
